(19) United States
(12) Patent Application Publication
(10) Pub. No.: US 2009/0074526 A1
(43) Pub. Date: Mar. 19, 2009

(54) Compound Relief Tap

(75) Inventor: Ho Keun Song, Incheon (KR)

Correspondence Address: VEDDER PRICE P.C., 222 N. LASALLE STREET, CHICAGO, IL, 60601, US

(73) Assignee: YG-1 CO., LTD., Incheon (KR)

(21) Appl. No.: 11/857,256

(22) Filed: Sep. 18, 2007

(51) Int. Cl. B23G 5/06; B23G 7/02

(52) U.S. Cl. 408/222; 408/220; 470/198

(57) ABSTRACT

The present disclosure is directed toward a compound relief tap, and more specifically, to a compound relief tap with domains made of a plurality of consecutive threads where each domain has different properties associated with variable thread parameters and variable geometrical arrangements such a variation of a taper angle and relief angles for different portions of domain threads or between domains. In a first embodiment, all of the threads in a domain have a given geometrical arrangement. In a second embodiment, several of the threads of the domain possess the geometrical arrangement. In a third embodiment, only the thread of the domain possesses the geometrical arrangement. And in a fourth embodiment, alternative threads in the domain possess the geometrical arrangement. What is also contemplated is a variation in geometrical arrangement between successive domains for any of these threaded domains.

### FIELD OF THE DISCLOSURE

The present disclosure is directed toward a compound relief tap, and more specifically, to a compound relief tap with domains made of a plurality of consecutive threads where each domain has different properties associated with variable thread parameters and variable geometrical arrangements such a variation of a taper angle and relief angles for a different portions of domain threads or between domains.

### BACKGROUND OF THE INVENTION

Threads are used to convert torque into linear force between two elements. The first element has male threads on its outer surface and it is screwed into a second element with female threads on the inner surface of an opening, or vice versa. To form threads on the inner surface of an opening, a hole is generally drilled using a drill bit. The drill bit, because of its rapid speed of rotation, leaves the surface of the hole flat. Threads must be added to the surface in a second step using a tap.

Taps are cutting tools used to create screw threads in solid substances including but not limited to metal, wood, or plastic by shaving away thread shapes on the inner surface of a cylindrical hole. Male taps (i.e., taps capable of forming female threads inside of holes) are generally sold in the form of a long cylindrical tool body tool with a threaded length and a shank often equipped with an end portion for positioning the tap in a torque creating support. A user attaches the tap inside the torque support, places the tap on the hole, and screws the tap into the hole to create threads. Taps often include flute openings made longitudinally along the thread length and define lands with threaded surfaces where chips of removed material from the surface of the hole are pushed for removal. FIG. 4 shows a tap 100 placed inside a torque creating support 36 operated by a user 40 and stabilized in a grip 38.

In one device from the prior art shown in FIG. 1, the tap has a series of regularly spaced and identically shaped threads along the entire thread length. As a result, the user must place a very high level of torque in the first couple of threads where all of the metal is shaved away from the hole. Over time, the high torque placed upon the first few threads dulls the tap's cutting edges and results in a tap where the torque needed to operate the tool increases substantially. Other taps have tried with some level of success to correct this inherent problem.

FIG. 2 shows a tap where, while the pitch and the minor diameter of each thread remains constant over the thread length, the major diameter (or outside diameter) is progressively increased until the desired thread geometry is reached. Consequently, each thread removes a thinner layer of material and less torque is required to operate the first few threads of the tap. This type of tap creates more problems than it resolves. For example, the user is no longer capable of creating completely formed threads over the entire length of a hole to be threaded. To produce the threads, the tap must be inserted throughout the threaded length. These taps are not capable of threading holes with closed bottoms where threads are needed over the entire length of the hole. In addition, as the tap is inserted, more threads are needed to cut the surface of the material, each cutting at a lesser thickness. As a consequence, a higher torque may be expected based on a greater frictional surface and cutting surface between the tap and the hole.

FIG. 3 illustrated another unsuccessful attempt at alleviating these problems, where a chamfer angle is created in the first threads to cut threads with the right pitch but where less material is removed by increasing the chamfer angle, the major diameter of the crest of each thread. Efforts to soften chamfer torque and associated heat and wear by modifying threads only results in a greater instability of operations and an inability to operate the tap at different depths.

What is needed is a tap designed for longer tool life by limiting flank wear and reducing operating heat and torque by selectively placing effective cutting surfaces at the adequate positions while relieving some of the inoperative sections of threads to limit friction associated with torque and heat.

### BRIEF SUMMARY OF THE INVENTION

The present disclosure is directed toward a compound relief tap, and more specifically, to a compound relief tap with domains made of a plurality of consecutive threads where each domain has different properties associated with variable thread parameters and variable geometrical arrangements such a variation of a taper angle and relief angles for a different portions of domain threads or between domains. In a first embodiment, all of the threads in a domain have a given geometrical arrangement. In a second embodiment, several of the threads of the domain possess the geometrical arrangement. In a third embodiment, only the thread of the domain possesses the geometrical arrangement. And in a fourth embodiment, alternative threads in the domain possess the geometrical arrangement. What is also contemplated is a variation in geometrical arrangement between successive domains for any of these threaded domains.

### BRIEF DESCRIPTION OF THE DRAWINGS

The features of the present disclosure are believed to be novel and are set forth with particularity in the appended claims. The disclosure may best be understood by reference to the following description taken in conjunction with the accompanying drawings, where the figures that employ like reference numerals identify like elements.

FIG. 1 is side view of a first tap from the prior art.

FIG. 2 is a side view of a chamfered tap from the prior art with a constant chamfer.

FIG. 3 is a side view of second chamfered tap from the prior art with variable thread height.

FIG. 4 is an illustration of a fluted tap with a torque-creating support in a piece secured to a vice grip according to a first embodiment of the present disclosure.

FIG. 5A is a side view used to illustrate schematically the nomenclature of tap cutting tools.

FIG. 5B is a detail of one of the lands located between two flutes of the tap cutting tool of FIG. 5A.

FIG. 5C is a top view of the tap cutting tool of FIG. 5A as seen from the cut line 5-5C as shown in FIG. 5A.

FIG. 5D is a sectional view without shading of the tap cutting tool of FIG. 5A as seen from the cut line 5D-5D as shown in FIG. 5A.

FIG. 6 is a segmented view of a tapered threaded region with domains of a compound relief tap according to a first embodiment of the present disclosure.

FIG. 7 is a segmented view of a tapered threaded region with domains of a compound relief tap according to another embodiment of the present disclosure.

FIG. 8 is a volumetric partial section view of a domain of a compound relief tap with major diameter relief according to another embodiment of the present disclosure.

FIG. 9 is a volumetric partial section view of a domain of a compound relief tap with pitch relief according to another embodiment of the present disclosure.

FIG. 10 is a volumetric partial section view of a domain of a compound relief tap with negative pitch flank relief according to another embodiment of the present disclosure.

FIG. 11 is a volumetric partial section view of a domain of a compound relief tap with heel relief according to another embodiment of the present disclosure.

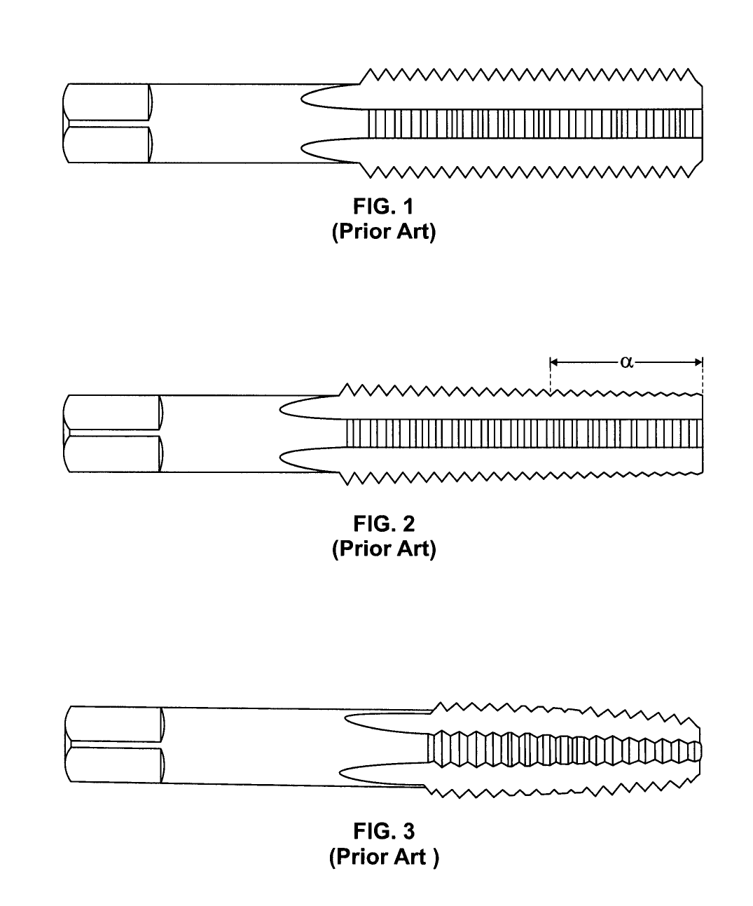

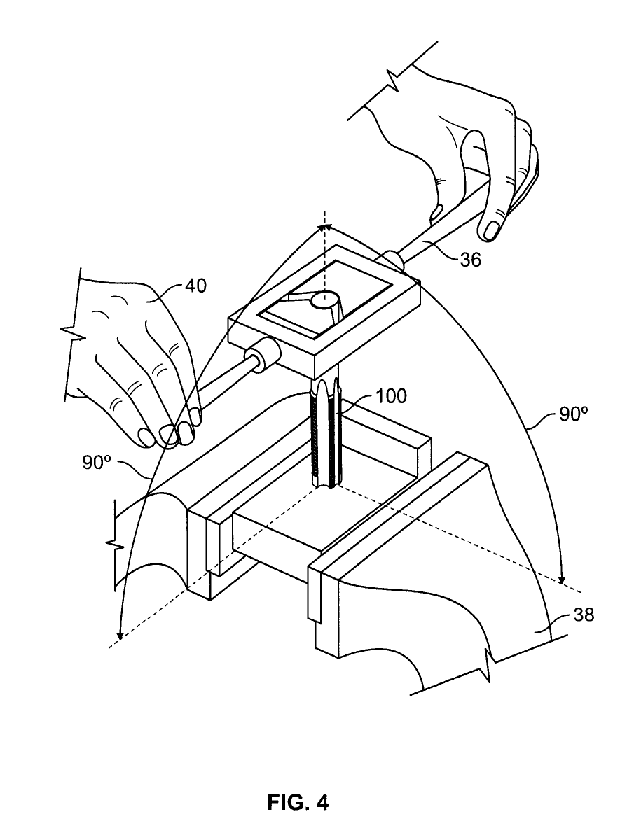

### DETAILED DESCRIPTION OF THE INVENTION

The present invention is not limited to the particular details of the device depicted and other modifications and applications may be contemplated. Further changes may be made in the above-described device without departing from the true spirit of the scope of the invention herein involved. It is intended, therefore, that the subject matter in the above depiction should be interpreted as illustrative, not in a limiting sense.

This disclosure relates to an improvement to a tap 100 designed to improve tool life. Tools are made of metal, and while a hard substance, they present some level of ductility when cutting other, softer metals. A cutting edge pushing into metal may be dulled if abrasion occurs locally and heats up due to local friction associated with cutting speeds, torque, and surface polish of the tool. Tool life depends on a plurality of factors including flank wear, hardness, cutting speed, surface temperature, torque, relief of threads, depth of cut, and feed rate. The relief of surfaces on threads that do not serve to enhance the mechanical operability of the tap 100 only increase friction between the tap 100 and the hole surface to be tapped.

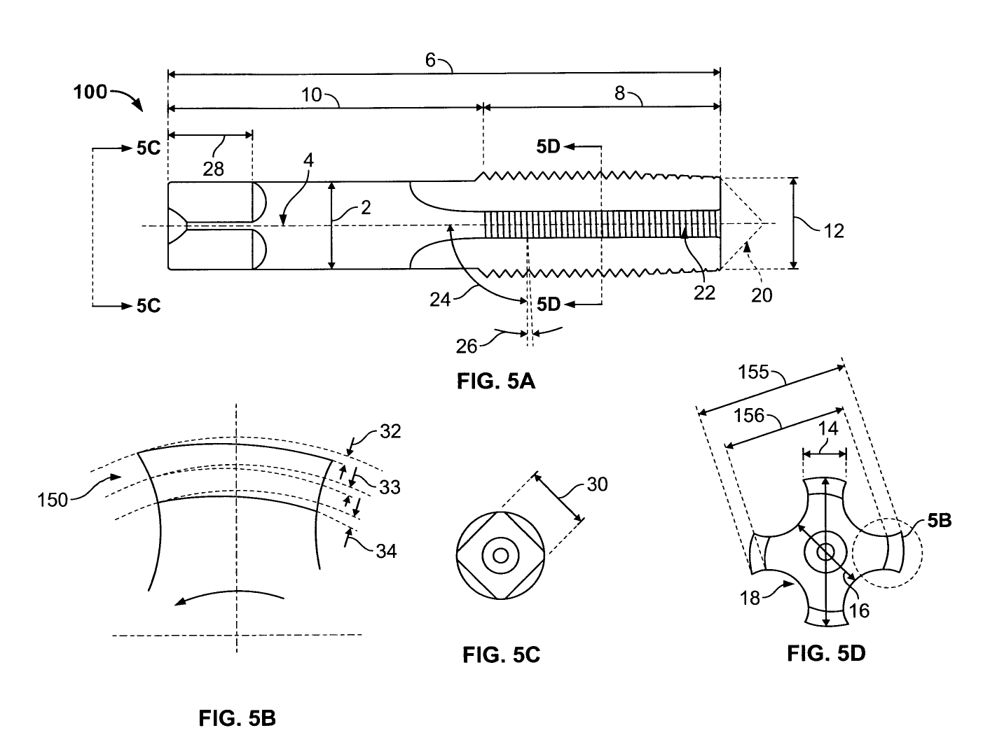

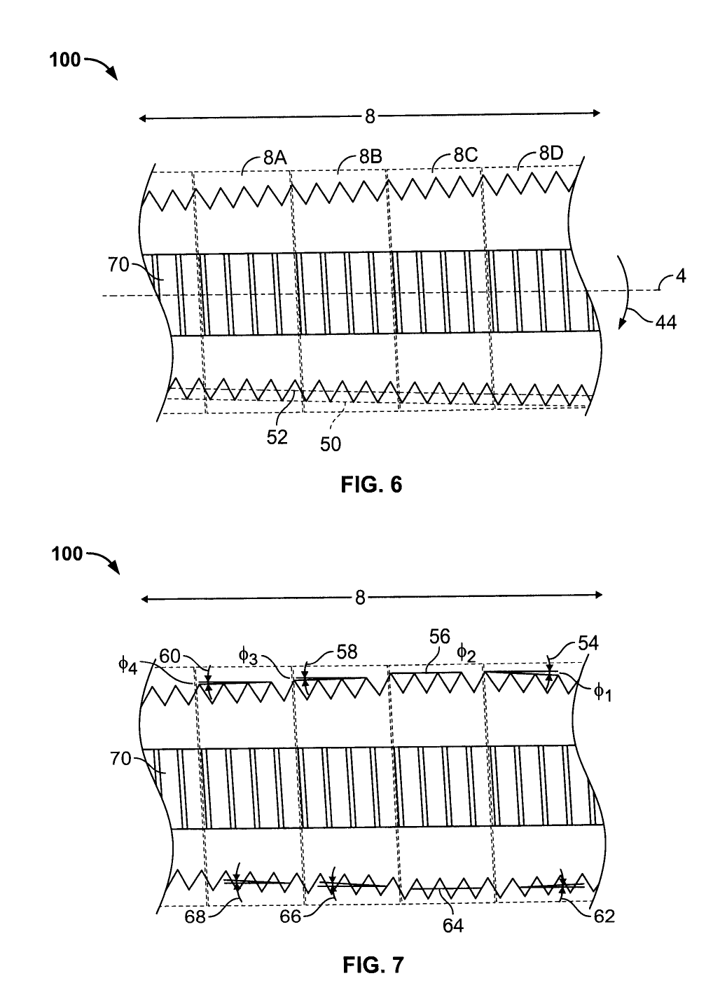

FIG. 4 illustrates how the tap 100 is operated by a user 40 to cut threads into a hole made in a block of material. The block is held in a vice grip 38 vertically using a torque-creating support 36, such as a small block with lateral support, movable by rotating two horizontal handles placed on each side of the torque-creating support 36. A user 40 then applies torque by rotating the handles in the horizontal plane. While a manual torque-creating support 36 is shown, what is contemplated within this disclosure is the use of any type of tap 100, using any engaging mechanism to rotate the tap and thus activate the cutting edges 150 shown in FIG. 5B about a longitudinal axis 4 as shown in FIG. 5A.

FIG. 5A illustrates a tap 100 with an overall length 6 that may be separated into a thread length 8 and a shank length 10 of a fixed shank diameter 2. The ratio of these two lengths is purely illustrative, and it is understood that these lengths vary according to the model and type of tap 100. The shank length 10 can also include a driving length 28 where the tap 100 is secured to a torque-creating support. This driving length 28 is also of a geometry as shown in FIG. 5C to allow for the coupling of the tap 100 to any needed torque-creating support. While a square attachment 30 is shown, any attachment is contemplated.

Flutes 18 as shown in FIG. 5D separate lands 22 created in the threaded length 8 between two consecutive flutes 18. In one embodiment as shown in FIG. 5D, four flutes 18 are positioned at 90 degrees circumferentially around the thread length 8. Other taps may have flutes 18 of smaller radii, variable curvature, placed around a cylindrical tool body or minor diameter 12 of different size to create a tap 100 with five or more flutes 18 or three or less flutes 18. What is also shown is a tap 100 with straight flutes 18 as shown in FIG. 5A. What is also contemplated is the use of helical angle, a spiral, or any other type of flute 18 that is not aligned with the longitudinal axis 4 of the tap 100.

Returning to FIG. 5A, the threaded length 8 comprises a series of threads shown in V shape having a thread lead angle 26 corresponding to a pitch or average median thread distance between two consecutive threads. In some embodiments, as shown by dashed lines, the tap 100 includes a point 20. FIG. 5D is a sectional view without shading of the tap cutting tool of FIG. 5A as seen from the cut line 5D-5D as shown in FIG. 5A. This section shows the land width 14, a section with threads having a minor diameter 156 and a major diameter 155. FIGS. 5A-5D show that the cylindrical tool body of the tap 100 includes a longitudinal axis 4 rotatable about the longitudinal axis 4 and having successively, a shank of shank length 10 and a threaded length 8 with at least a flute 18 for creating at least a land 22 with a front cutting surface 150 with a cutting edge 140 and a heel 130 as shown in FIG. 8. Each thread in the threaded length 22 is defined by a minor diameter 156 as the base 96 of a thread a major diameter 155 as the crest 94 of the thread with a leading flank 92 and a trailing flank 131 intersecting at a crest 94 separated by an adjacent thread by a pitch 132 measured at a pitch diameter 133.

The threaded length 8 is also divided into a series of successive domains 8A, 8B, 8C, 8D, etc. as shown in FIG. 6, each domain having a fixed number of successive threads 70 along the threaded length 8 and each having a geometrical arrangement. While four successive domains 8A to 8D are shown, what is contemplated is the use of any number of domains, based on the total length of the threaded length 8. In one contemplated embodiment, a tap 100 has between 30 and 90 threads and can be divided into any number of domains consisting of at least 2 threads. FIG. 6 also shows a proposed angle of rotation 44 for the threaded length 8.

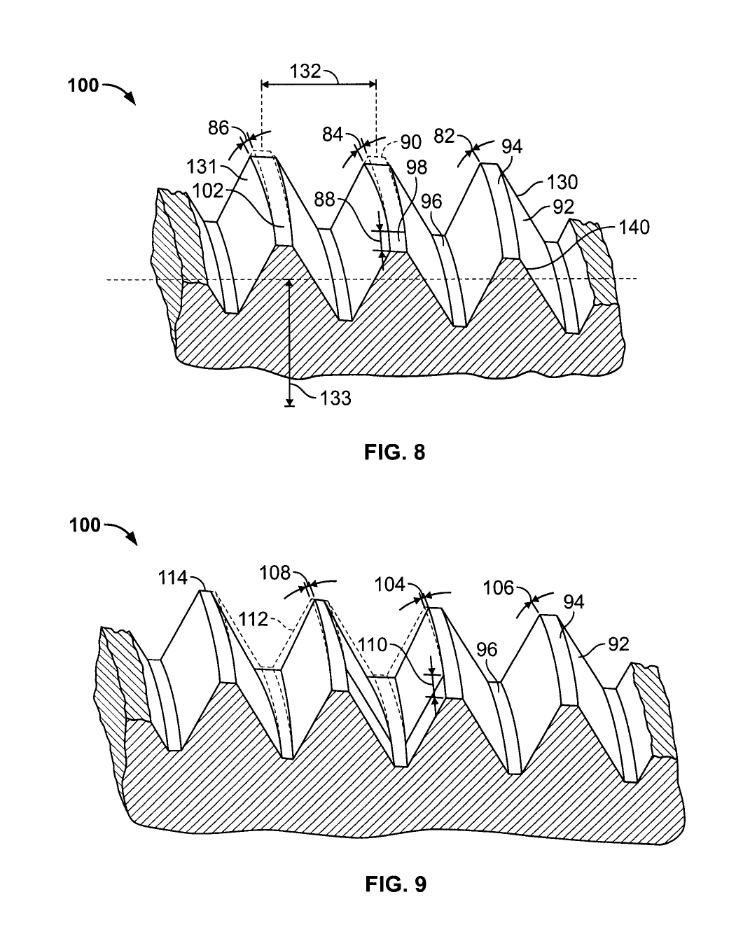

In one embodiment as shown in FIGS. 6 and 7, the geometrical arrangement is a taper angle Phi (Φ) shown as Φ1, Φ2, Φ3, and Φ4. FIG. 6 shows tapered consecutive domains with the same taper angle measured either at the major diameter 50 or the pitch diameter 52. FIG. 7 shows a tap 100 where each domain has a different taper angle Φ1, Φ2, Φ3, and Φ4 measured either from the major diameter 54, 56, 58, and 60, or measured from the pitch diameter 62, 64, 66, and 68. The taper angle Φ may be a front taper Φ3 and Φ4, a back taper Φ1, or no taper Φ2 for each successive domain. In another embodiment, the taper angle Φ is defined in relation to the minor diameter.

In another embodiment, shown in FIGS. 5B, and 8 to 11, the geometrical arrangement is a thread cutting edge relief 32 as shown on FIG. 5B 98 for each of the fixed number of successive threads in each successive domain. FIGS. 5B and 8 show a thread cutting edge relief 32 that may be an eccentric relief 86, a con-eccentric relief 84 (with concentric margin 88), or a concentric relief 82 for each successive domain. As shown in FIG. 8, the thread cutting edge relief 32 is defined in relation to the major diameter 155. Dashed lines show the removed relief material from normative threads or threads with concentric relief 82. In yet another embodiment, the thread cutting edge relief 34 of FIG. 5B is defined in relation to the minor diameter 156.

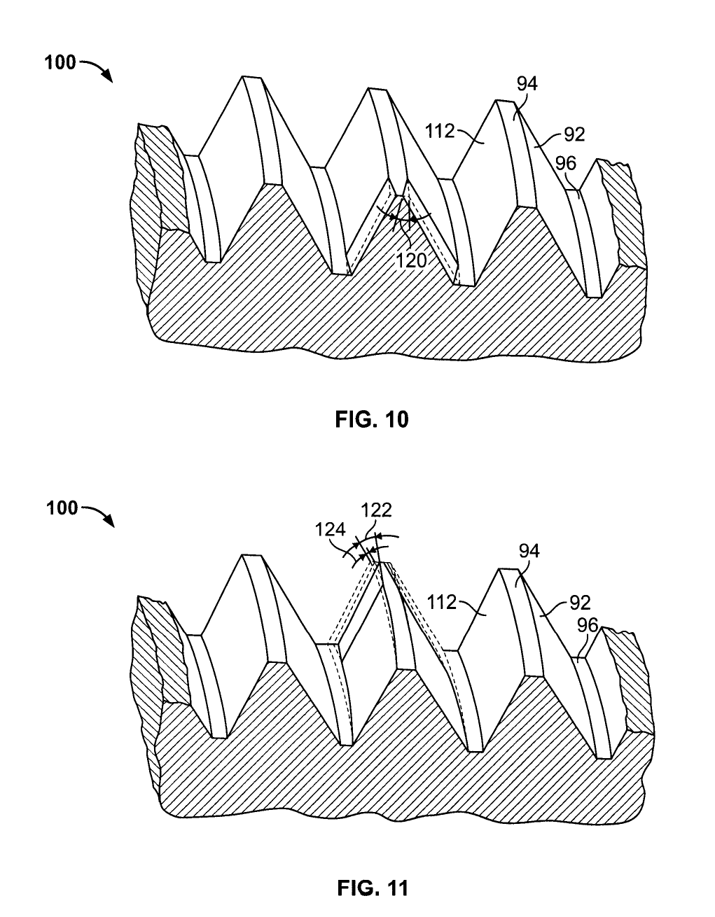

FIGS. 5B and 9 show the thread cutting edge relief 33 as part of leading flank 92 and trailing flank 112 defined as a relief of the pitch diameter 133. Similarly, the angular value of the taper angle for each successive domain differs and an angular value of the thread cutting edge relief for each successive domain differs. What is shown by dashed lines is the section envelope of the normative thread with a concentric relief on the pitch relief. The figure illustrates a con-eccentric relief 104 (with concentric margin 110), an eccentric relief 108, and a concentric relief 106 for the pitch relief at the pitch diameter 133, respectively.

In one alternate embodiment, at least a portion of thread for each of the series of successive domains having a geometrical arrangement. In yet another embodiment shown in FIG. 10, the pitch relief (or the major diameter relief, not shown) is a high negative relief 120 of the leading flank 92 and the trailing flank 112 at the cutting edge for each of the fixed number of successive threads in each successive domain. In yet another embodiment as shown in FIG. 11, the geometrical arrangement is a double or high positive relief 122 of the leading flank and the trailing flank at the heel of the land for each of the fixed number of successive threads in each successive domain.

In one contemplated embodiment, the geometrical arrangement of each successive domain is an alternating sequence within each successive domain of a thread of a single land on of the pitch with a variable parameter and the remaining threads of the other land of the pitch without the variable parameter; and yet in another embodiment, a single thread for each of the series of successive domains has a geometrical arrangement as defined herebefore.

What is also contemplated is any variation, using the principle of domains within a threaded length 8, of different threads using the above-defined reliefs of threads or any other relief based on another geometrical parameter associated with the art of taps. The above nomenclature, definitions, and associated illustrations correspond to the United States Cutting Tool Institute standards for TAPS GROUND THREAD, which are hereby fully incorporated herein by reference. This standard is also published as the American National Standard for Taps-Cut and Ground Thread, ANSI B94.9 also hereby fully incorporated herein by reference. In the case of conflict between theses definitions, nomenclatures, and associated illustrations, the terms defined within the body of this specification prevail upon the Cutting Tool Institute standard, which in turn prevails upon the ANSI standard.

It is understood that the preceding is merely a detailed description of some examples and embodiments of the present invention and that numerous changes to the disclosed embodiments can be made in accordance with the disclosure herein without departing from the spirit or scope of the invention. The preceding description, therefore, is not meant to limit the scope of the invention but to provide sufficient disclosure to one of ordinary skill in the art to practice the invention without undue burden.

What is claimed is:

1. A tap for cutting a thread in a workpiece, comprising:
a cylindrical tool body having a longitudinal axis rotatable about the longitudinal axis and having successively along the cylindrical tool body a shank and a threaded length with at least a flute for creating at least a land with a front cutting face with a cutting edge, and a heel,
wherein each thread in the threaded length is defined by a minor diameter and a major diameter with a leading flank and a trailing flank intersecting at a crest separated from an adjacent thread by a pitch measured at a pitch diameter, and
wherein the threaded length is divided in a series of successive domains each having a fixed number of successive threads along the threaded length and each having a geometrical arrangement.

2. The tap of claim 1, wherein the geometrical arrangement is a taper angle for each of the fixed number of successive threads in each successive domain.

3. The tap of claim 2, wherein the taper angle is a front taper, a back taper, or no taper for each successive domain.

4. The tap of claim 3, wherein the taper angle is defined in relation to the major diameter.

5. The tap of claim 3, wherein the taper angle is defined in relation to the minor diameter.

6. The tap of claim 3, wherein the taper angle is defined in relation to the pitch diameter.

7. The tap of claim 1, wherein the geometrical arrangement is a thread cutting edge relief for each of the fixed number of successive threads in each successive domain.

8. The tap of claim 7, wherein the thread cutting edge relief is an eccentric relief, a con-eccentric relief, or a concentric relief for each successive domain.

9. The tap of claim 8, wherein the thread cutting edge relief is defined in relation to the major diameter.

10. The tap of claim 8, wherein the thread cutting edge relief is defined in relation to the minor diameter.

11. The tap of claim 8, wherein the thread cutting edge relief is defined in relation to the pitch diameter.

12. The tap of claim 2, wherein an angular value of the taper angle for each successive domain differs.

13. The tap of claim 7, wherein an angular value of the thread cutting edge relief for each successive domain differs.

14. A tap for cutting a thread in a workpiece, comprising:
a cylindrical tool body having a longitudinal axis rotatable about the longitudinal axis and having successively along the cylindrical tool body, a shank, and a threaded length with at least a flute for creating at least a land with a front cutting face with a cutting edge and a heel,
wherein each thread in the threaded length is defined by a minor diameter and a major diameter with a leading flank and a trailing flank intersecting at a crest separated from an adjacent thread by a pitch measured at a pitch diameter,
wherein the threaded length is divided in a series of successive domains each having a fixed number of successive threads along the threaded length and segmented into portions of thread on the successive threads along successive lands, and
wherein at least a portion of thread for each of the series of successive domains having a geometrical arrangement.

15. The tap of claim 14, wherein the geometrical arrangement is a thread cutting edge relief for each of the fixed number of successive threads in each successive domain.

16. The tap of claim 15, wherein the thread cutting edge relief is an eccentric relief, a con-eccentric relief, or a concentric relief for each successive domain.

17. The tap of claim 16, wherein the thread cutting edge relief is defined in relation to the major diameter.

18. The tap of claim 16, wherein the thread cutting edge relief is defined in relation to the minor diameter.

19. The tap of claim 16, wherein the thread cutting edge relief is defined in relation to the pitch diameter.

20. The tap of claim 14, wherein the geometrical arrangement is a high negative relief of the leading flank and the trailing flank at the cutting edge for each of the fixed number of successive threads in each successive domain.

21. The tap of claim 14, wherein the geometrical arrangement is a double or high positive relief of the leading flank and the trailing flank at the heel of the land for each of the fixed number of successive threads in each successive domain.

22. The tap of claim 15, wherein the thread cutting edge relief for each of the fixed number of successive threads is variable for each successive domain.

23. The tap of claim 20, wherein the high negative relief for each of the fixed number of successive threads is variable for each successive domain.

24. The tap of claim 21, wherein the double or high positive relief for each of the fixed number of successive threads is variable for each successive domain.

25. The tap of claim 14, wherein the geometrical arrangement of each successive domain is an alternating sequence within each successive domain of a thread with a variable parameter and a thread without the variable parameter.

26. The tap of claim 25, wherein the variable parameter is a thread cutting edge relief.

27. The tap of claim 26, wherein the thread cutting edge relief is an eccentric relief, a con-eccentric relief, or a concentric relief.

28. The tap of claim 26, wherein the thread cutting edge relief is defined in relation to the major diameter.

29. The tap of claim 26, wherein the thread cutting edge relief is defined in relation to the minor diameter.

30. The tap of claim 26, wherein the thread cutting edge relief is defined in relation to the pitch diameter.

31. The tap of claim 25, wherein the variable parameter is a high negative relief of the leading flank and the trailing flank at the cutting edge.

32. The tap of claim 25, wherein the variable parameter is a double or high positive relief of the leading flank and the trailing flank at the heel of the land.

33. The tap of claim 14, wherein the geometrical arrangement of each successive domain is an alternate sequence within each successive domain of a thread of a single land on of the pitch with a variable parameter and the remaining threads of the other land of the pitch without the variable parameter.

34. The tap of claim 33, wherein the variable parameter is a thread cutting edge relief.

35. The tap of claim 34, wherein the thread cutting edge relief is an eccentric relief, a con-eccentric relief, or a concentric relief.

36. The tap of claim 34, wherein the thread cutting edge relief is defined in relation to the major diameter.

37. The tap of claim 34, wherein the thread cutting edge relief is defined in relation to the minor diameter.

38. The tap of claim 34, wherein the thread cutting edge relief is defined in relation to the pitch diameter.

39. The tap of claim 33, wherein the variable parameter is a high negative relief of the leading flank and the trailing flank at the cutting edge.

40. The tap of claim 33, wherein the variable parameter is a double or high positive relief of the leading flank and the trailing flank at the heel of the land.

41. A tap for cutting a thread in a workpiece, comprising:
a cylindrical tool body having a longitudinal axis rotatable about the longitudinal axis and having successively along the cylindrical tool body, a shank, and a threaded length with at least a flute for creating at least a land with a front cutting face with a cutting edge and a heel,
wherein each thread in the threaded length is defined by a minor diameter and a major diameter with a leading flank and a trailing flank intersecting at a crest separated from an adjacent thread by a pitch measured at a pitch diameter,
wherein the threaded length is divided in a series of successive domains each having a fixed number of successive threads along the threaded length and segmented into portions of thread on the successive threads along successive lands, and
wherein a single thread for each of the series of successive domains having a geometrical arrangement.

42. The tap of claim 41, wherein the geometrical arrangement is a thread cutting edge relief in each successive domain.

43. The tap of claim 42, wherein the thread cutting edge relief is an eccentric relief, a con-eccentric relief, or a concentric relief for each successive domain.

44. The tap of claim 42, wherein the thread cutting edge relief is defined in relation to the major diameter.

45. The tap of claim 42, wherein the thread cutting edge relief is defined in relation to the minor diameter.

46. The tap of claim 42, wherein the thread cutting edge relief is defined in relation to the pitch diameter.

47. The tap of claim 41, wherein the geometrical arrangement is a high negative relief of the leading flank and the trailing flank at the cutting edge in each successive domain.

48. The tap of claim 41, wherein the geometrical arrangement is a double or high positive relief of the leading flank and the trailing flank at the heel of the land in each successive domain.

49. The tap of claim 42, wherein the thread cutting edge relief is variable for each successive domain.

50. The tap of claim 47, wherein the high negative relief is variable for each successive domain.

51. The tap of claim 48, wherein the double or high positive relief is variable for each successive domain.
